(19) United States
(12) Patent Application Publication
(10) Pub. No.: US 2012/0329439 A1
(43) Pub. Date: Dec. 27, 2012

(54) MOBILE DEVICE CAPABLE OF AUTOMATICALLY SWITCHING OPERATION PROFILES AND METHOD THEREOF

(75) Inventor: CHI-SHENG GE, Tu-Cheng (TW)

(73) Assignee: HON HAI PRECISION INDUSTRY CO., LTD., Tu-Cheng (TW)

(21) Appl. No.: 13/224,302

(22) Filed: Sep. 1, 2011

(30) Foreign Application Priority Data
Jun. 24, 2011 (TW) 100122345

(51) Int. Cl. H04W 8/00

(52) U.S. Cl. 455/418

(57) ABSTRACT

A mobile device includes an acceleration sensing unit, a storage unit, a parameter obtaining unit, and a processing unit. The acceleration sensor senses acceleration of the mobile device. The storage unit stores an operation profile database having a plurality of operation profiles, an operation profile table mapping a sensed acceleration and a current status of a user of the mobile phone to one of the operation profiles, and a parameter obtaining table mapping a sensed acceleration to a parameter. The processing unit determines to obtain which parameter according to the sensed acceleration and the parameter obtaining table, directs the parameter obtaining unit to obtain the determined parameter, determines a current status of the user according to the obtained parameter, and switches the mobile device to a target operation profile according to the sensed acceleration, the determined current status of the user, and the operation profile table. A related method is also provided.

### BACKGROUND

1. Technical Field

The present disclosure relates to mobile devices and, particularly, to a mobile device capable of automatically switching operation profiles and a method thereof.

2. Description of Related Art

Many mobile devices such as mobile phones allow users to set multiple operation profiles. Each operation profile allows customization of different settings, such as ring volume, selected ring tone, vibration on/off, keypad tones, display brightness, and so on. Mobile phone users manually set the profile to use, according to their immediate environment and/or their preferences at the time. It is, however, rather easy for users to forget to switch operation profiles when their environment changes, for example, from a loud environment to a quiet environment, which can be troublesome to users. As such, there is a need to provide a manner by which users need not manually switch operation profiles.

### BRIEF DESCRIPTION OF THE DRAWINGS

The components of the drawings are not necessarily drawn to scale, the emphasis instead being placed upon clearly illustrating the principles of a mobile device capable of automatically switching operation profiles and a method thereof. Moreover, in the drawings, like reference numerals designate corresponding parts throughout several views.

FIG. 1 is a block diagram of a mobile device capable of automatically switching operation profiles, in accordance with an exemplary embodiment.

FIG. 2 is a flowchart of a method for automatically switching operation profiles, in accordance with an exemplary embodiment.

### DETAILED DESCRIPTION

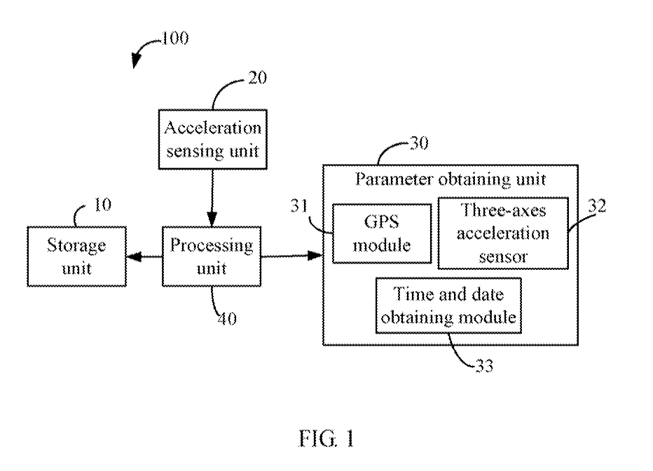

Referring to FIG. 1, an embodiment of a mobile device 100 capable of automatically switching operation profiles is illustrated. The mobile device 100 may be a mobile phone. The mobile device 100 includes a storage unit 10, an acceleration sensing unit 20, a parameter obtaining unit 30, and a processing unit 40. The acceleration sensing unit 20 senses acceleration a0 of the mobile phone 100. The storage unit 10 stores an operation profile database having a number of operation profiles, such as an office profile, a home profile, and so on. The storage unit 10 stores an operation profile table (shown below) mapping a sensed acceleration a0 and a current status of a user of the mobile device 100 to one operation profile. That is, the sensed acceleration a0 and the current status of the user are cooperatively employed by the mobile device 100 to determine when to switch operation profiles and determine to switch to which operation profile. The storage unit 10 further stores a parameter obtaining table (shown below) mapping an acceleration a0 to a parameter. Each parameter is used for determining a current status of the user, for example, determining whether the user is running or driving. The processing unit 40 determines to obtain which parameter according to the sensed acceleration a0 and the parameter obtaining table, directs the parameter obtaining unit 30 to obtain the determined parameter, and determines a current status of the user according to the obtained parameter. The detailed method of determining which parameter to obtain and determining a current status of the user according to the obtained parameter will be described below. The processing unit 40 further switches the mobile device 100 to a target operation profile according to the sensed acceleration a0, the determined current status of the user, and the operation profile table.

Operation Profile Table

| | | |
|---|---|---|
| a0 | Current status | Operation profile |
| a0 >= a1 | Driving | Driving profile 1 |
| a2 < a0 < a3 | Running or walking | Running or walking profile 2 |
| a0 = 0 | In office | Office profile 3 |
| | At home | Home profile 4 |

Parameter Obtaining Table

| | |
|---|---|
| a0 | Parameter |
| a0 >= a1 | Geographic information |
| a2 < a0 < a3 | X-axis, Y-axis, and Z-axis accelerations |
| a0 = 0 | Current time and date |

The parameter obtaining unit 30 includes a global positioning system (GPS) module 31, a three-axes acceleration sensor 32, and a time and date obtaining module 33.

The GPS module 31 obtains current geographic information of the mobile device 100. If the processing unit 40 determines that a0>=a1, the processing unit 40 directs the GPS module 31 to obtain current geographic information of the mobile device 100 according to the parameter obtaining table, and determines whether the user is driving according to the geographic information. In this embodiment, if the current geographic information is on a road, the processing unit 40 determines that the user is driving. The processing unit 40 switches the mobile device 100 to a driving profile according to the sensed acceleration a0, the determined current status, and the operation profile table.

The acceleration sensor 32 senses X-axis, Y-axis, Z-axis accelerations of the mobile device 100. In this embodiment, the acceleration sensor 32 is a gyroscope. If the processing unit 40 determines that a2<a0<a3, the processing unit 40 directs the acceleration sensor 32 to sense X-axis, Y-axis, Z-axis accelerations of the mobile device 100 according to the parameter obtaining table, and determines whether the user is walking or running according to the sensed X-axis, Y-axis, Z-axis accelerations of the mobile device 100. If the user is walking or running, the processing unit 40 switches the mobile device 100 to a walking or running profile according to the sensed acceleration a0, the determined current status, and the operation profile table. In this embodiment, the processing unit 40 determines an acceleration a according to the sensed X-axis, Y-axis, Z-axis accelerations and a predetermined formula a=sqrt(X̂2+Ŷ2+Ẑ2). If the determined acceleration a falls within a first preset range, the processing unit 40 determines that the user is walking. If the determined acceleration a falls within a second preset range, the processing unit 40 determines that the user is running.

The time and date obtaining module 33 obtains current time and date. The storage unit 10 further stores a user's schedule recording office times and home times. If the processing unit 40 determines that a0=0, the processing unit 40 directs the time and date obtaining module 33 to obtain current time and date according to the parameter obtaining table, and determines whether the user is in office or at home according to the obtained current time and date and the schedule. If the user is in office, the processing unit 40 switches the mobile device 100 to an office profile according to the sensed acceleration a0, the determined current status, and the operation profile table. If the user is at home, the processing unit 40 switches the mobile device 100 to a home profile according to the sensed acceleration a0, the determined current status, and the operation profile table.

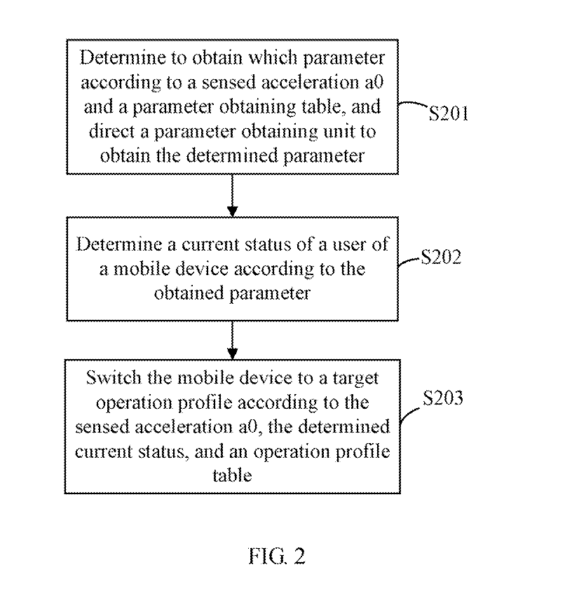

FIG. 2 is a flowchart of a method for switching operation profiles applied in the mobile device 100 of FIG. 1 in accordance with an exemplary embodiment.

In step S201, the processing unit 40 determines to obtain which parameter according to the sensed acceleration a0 and the parameter obtaining table, and directs the parameter obtaining unit 30 to obtain the determined parameter.

In step S202, the processing unit 40 determines a current status of the user according to the obtained parameter.

In step S203, the processing unit 40 switches the mobile device 100 to a target operation profile according to the sensed acceleration a0, the determined current status, and the operation profile table.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A mobile device capable of automatically switching operation profiles, comprising:
an acceleration sensing unit to sense acceleration of the mobile device;
a storage unit storing an operation profile database having a plurality of operation profiles, an operation profile table mapping an acceleration sensed by the acceleration sensing unit and a current status of a user of the mobile phone to one of the operation profiles, and storing a parameter obtaining table mapping an acceleration sensed by the acceleration sensing unit to a parameter;
a parameter obtaining unit; and
a processing unit to determine to obtain which parameter according to the acceleration sensed by the acceleration sensing unit and the parameter obtaining table, direct the parameter obtaining unit to obtain the determined parameter, determine a current status of the user according to the obtained parameter, and switch the mobile device to a target operation profile according to the acceleration sensed by the acceleration sensing unit, the determined current status of the user, and the operation profile table.

2. The mobile device as described in claim 1, wherein the parameter obtaining unit comprises a global positioning system (GPS) module, if the acceleration sensed by the acceleration sensing unit is greater than or equal to a preset acceleration, the processing unit is to direct the GPS module to obtain current geographic information of the mobile device according to the parameter obtaining table, the processing unit is further to determine whether the user is driving according to the geographic information, and switch the mobile device to a driving profile according to the acceleration sensed by the acceleration sensing unit, the determined user status, and the operation profile table if the user is determined driving.

3. The mobile device as described in claim 2, wherein the processing unit is to determine that the user is driving if the current geographic information of the mobile device is on a road.

4. The mobile device as described in claim 1, wherein the parameter obtaining unit comprises a three-axis acceleration sensor, if the acceleration sensed by the acceleration sensing unit falls within a preset acceleration range, the processing unit is to direct the three-axes acceleration sensor to sense X-axis, Y-axis, Z-axis accelerations of the mobile device according to the parameter obtaining table, the processing unit is further to determine whether the user is walking or running according to the sensed X-axis, Y-axis, Z-axis accelerations of the mobile device and a preset formula, and switch the mobile device to a walking or running operation profile according to the acceleration sensed by the acceleration sensing unit, the determined user status, and the operation profile table if the user is determined walking or running.

5. The mobile device as described in claim 1, wherein the storage unit further stores a user's schedule recording office times and home times, the parameter obtaining module comprises a time and date obtaining module, if the acceleration sensed by the acceleration sensing unit is equal to zero, the processing unit is to direct the time and date obtaining module to obtain current time and date according to the parameter obtaining table, the processing unit is further to determine whether the user is in office or at home according to the obtained current time and date and the user's schedule, switch the mobile device to an office profile according to the acceleration sensed by the acceleration sensing unit, the determined user status, and the operation profile table if the user is in office, and switch the mobile device to a home profile according to the acceleration sensed by the acceleration sensing unit, the determined user status, and the operation profile table if the user is at home.

6. A method for automatically switching operation profiles applied in a mobile device, the mobile device comprising an acceleration sensing unit to sense acceleration of the mobile device, a parameter obtaining unit, and a storage unit, the storage unit storing an operation profile database having a plurality of operation profiles, an operation profile table mapping an acceleration sensed by the acceleration sensing unit and a current status of a user of the mobile phone to one of the operation profiles, and storing a parameter obtaining table mapping an acceleration sensed by the acceleration sensing unit to a parameter, the method comprising:
determining to obtain which parameter according to the acceleration sensed by the acceleration sensing unit and the parameter obtaining table;
directing the parameter obtaining unit to obtain the determined parameter;
determining a current status of a user of the mobile device according to the obtained parameter; and
switching the mobile device to a target operation profile according to the acceleration sensed by the acceleration sensing unit, the determined current status of the user, and the operation profile table.

7. The method as described in claim 6, comprising:
directing the parameter obtaining unit to obtain current geographic information of the mobile device if the acceleration sensed by the acceleration sensing unit is greater than or equal to a preset acceleration;
determining whether the user is driving according to the geographic information; and
switching the mobile device to a driving profile according to the acceleration sensed by the acceleration sensing unit, the determined current status of the user, and the operation profile table if the user is determined driving.

8. The method as described in claim 6, comprising:
directing the parameter obtaining unit to obtain X-axis, Y-axis, Z-axis accelerations of the mobile device according to the parameter obtaining table if the acceleration sensed by the acceleration sensing unit falls within a preset acceleration range;
determining whether the user is walking or running according to the sensed X-axis, Y-axis, Z-axis accelerations of the mobile device and a preset formula; and
switching the mobile device to a walking or running profile according to the acceleration sensed by the acceleration sensing unit, the determined current status of the user, and the operation profile table if the user is determined walking or running.

9. The method as described in claim 6, comprising:
directing the parameter obtaining unit to obtain current time and date according to the parameter obtaining table if the acceleration sensed by the acceleration sensing unit is equal to zero;
determining whether the user is in office or at home according to the obtained current time and date and a user's schedule, the user's schedule recording office times and home times;
switching the mobile device to an office profile according to the acceleration sensed by the acceleration sensing unit, the determined current status of the user, and the operation profile table if the user is in office; and
switching the mobile device to a home profile according to the acceleration sensed by the acceleration sensing unit, the determined current status of the user, and the operation profile table if the user is at home.
